(19) United States
(12) Patent Application Publication
(10) Pub. No.: US 2007/0122522 A1
(43) Pub. Date: May 31, 2007

(54) Beer additive and method

(76) Inventor: Ian David Kaehne, Belair (AU)

Correspondence Address: DEFILLO & ASSOCIATES, INC., P.O. Box 14104, Clearwater, FL, 33766, US

(21) Appl. No.: 10/574,874

(22) PCT Filed: Oct. 8, 2004
(86) PCT No.: PCT/AU04/01392

§ 371 Date: Apr. 6, 2006

(30) Foreign Application Priority Data
Oct. 8, 2003 (AU) 2003905487

(51) Int. Cl. C12C 11/00

(52) U.S. Cl. 426/11

(57) ABSTRACT

A method for enhancing the taste of a beer with a mineral additive. The mineral additive comprises soluble compounds of the following minerals to the following ranges of final concentrations of the respective element in the finished beer, to enhance taste characteristics of the diluted beer when compared to a dilution solely with water. Group A minerals: calcium from 5.9 mg/L to 236 mg/L, and magnesium from 1.3 to 52 mg/L. Group B minerals: phophorus from 3.0 to 360 mg/L, potassium from 12 mg/L to 480 mg/L, silicon at 0.075 mg/L to 30 mg/L, sodium at 0.8 mg/L to 32 mg/L and chlorine at 0.9 mg/L to 36 mg/L. Group C minerals: boron from 0 to 76 μg/L, chromium from 0 to 0.4 μg/L, cobalt from 0 to 0.4 μg/L, copper from 0 to 17.2 μg/L, iodine from 0 to 5.2 μg/L, lithium from 0 to 1.6 μg/L, manganese from 0 to 1.6 μg/L, molybdenum from 0 to 2.0 μg/L, nickel from 0 to 2.0 μg/L, selenium from 0 to 136 μg/L, tin from 0 to 01.6 μg/L, vanadium from 0 to 0.12 μg/L and zinc from 0 to 104 μg/L. Group D minerals: iron 0 to 20 μg/L.

### FIELD OF THE INVENTION

This invention relates to additives for beer, and in one specific aspect additives that can be used in minimizing the impact, for example on taste, of diluting beers to produce low alcohol beers as well as a method of diluting beers, and in a second aspect to a method of modifying the taste profiles of beers.

### BACKGROUND TO THE INVENTION

Low alcoholic beverages, in particular beers, are returning to vogue. This follows considerable emphasis that has been placed on the role of alcohol in the impairment of driving capacity and other activities. Additionally it is considered generally desirable to reduce alcohol intake to maintain a healthy lifestyle. For brewers, production of low alcohol beers provides an avenue for reducing excise, and promoting consumption volumes.

There is a difficulty in providing a low alcohol beer whilst at the same time providing a satisfactory flavor profile. An approach adopted in the early part of the 20th century, during the so called prohibition in the United States of America, was a distillation using heat and/or vacuum to reduce the alcohol content to acceptable levels. Distillation is, however, expensive and in addition to removing alcohol it removes flavor compounds. When heat is used the taste of the undistilled portion can additionally be compromised.

Removal of alcohol by filtration such as reverse osmosis has also been suggested, however, again the process is relatively expensive and additionally can result in removal of flavor compounds with the alcohol.

A currently favored approach is to dilute relatively full strength and high gravity beer with water. The beer may have been produced from a wort with modified characteristics in particular stronger taste and body such that subsequent dilution produces a beverage with an acceptable flavor. Such modifications include reducing the relative fermentable mass of the wort by ensuring that some of the malt is not fermentable producing an inherently lower alcohol product. A range of other approaches can also be taken to attempt to give the low alcohol beverage as acceptable a taste as possible. Inevitably, however it has not been possible to fully compensate for flavor dilution with water or natural mineral waters, particularly where significant dilutions are required.

Use of additives have also been suggested for enhancing the flavor of beers in particular low alcohol base beers in which some of the flavor components have been depleted. It is thus suggested by Heusen, U.S. Pat. No. 1,401,700, to add a small quantity of volatile acids such as formic, acetic and propionic acids. Witt et al., U.S. Pat. No. 4,788,066, suggest that for the low alcohol beer disclosed therein that mash water should preferably contain certain salts to enhance the flavor and exemplifies potassium phosphate and potassium hydro phosphate salts to provide a level of potassium between 200 to 600 parts per million.

Additionally, in beer making generally, there is a problem with maintaining flavors between batches of product and typically beers on the market are blends. It is desirable to either have a more consistent flavor in full strength beers or to improve the flavor.

### SUMMARY OF THE INVENTION

It has been found, according to this invention, that the addition of certain levels of a complex mixture of minerals enhances the capacity to dilute beers by compensating somewhat for the reduction and disruption of flavors and taste characteristics (profiles) commensurate with dilution. Additionally, it is found that by the addition of the complex of minerals to beers of all strengths that flavor and taste perceptions are enhanced.

In a broad form of a first aspect the invention may be said to reside in a method of diluting a base beer with a mineral additive and water the base beer being diluted to between 0.5% and 90%, the mineral additive including soluble compounds of the following minerals to the following ranges of final concentrations in the finished beer of the respective element, to enhance taste characteristics of the diluted beer when compared to a dilution solely with water:

group A minerals: calcium from 5.9 mg/L to 236 mg/L, and magnesium from 1.3 to 52 mg/L

group B minerals: phophorus from 3.0 to 360 mg/L, potassium from 12 mg/L to 480 mg/L, silicon at 0.075 mg/L to 30 mg/L, sodium at 0.8 mg/L to 32 mg/L and chlorine at 0.9 mg/L to 36 mg/L,

group C minerals: boron from 0 to 76 μg/L, chromium from 0 to 0.4 μg/L, cobalt from 0 to 0.4 μg/L, copper from 0 to 17.2 μg/L, iodine from 0 to 5.2 μg/L, lithium from 0 to 1.6 μg/L, manganese from 0 to 1.6 μg/L, molybdenum from 0 to 2.0 μg/L, nickel from 0 to 2.0 μg/L, selenium from 0 to 136 μg/L, tin from 0 to 01.6 μg/L, vanadium from 0 to 0.12 μg/L and zinc from 0 to 104 μg/L,

group D minerals: iron 0 to 20 μg/L.

Alternatively all the minerals of groups A, B, C and D are added in dry form with minimal impact on dilution, or some of the minerals can be added as a solution whereas others can be added in dry form.

It is found that various types of beers benefit most from the addition of minerals at a diverse range of concentrations. Typically preferred ranges of the final elemental concentrations in some types of beers are set out below.

For a stout beer the minerals might typically be added to a final concentration in the beer as follows:

group A minerals: calcium from 70 mg/L to 143 mg/L, and magnesium from 15 mg/L to 32 mg/L

group B minerals: phophorus at least 36 mg/L, potassium from 144 mg/L to 288 mg/L, silicon at 9 mg/L to 18 mg/L, sodium at 9 mg/L to 20 mg/L and chlorine at 11 mg/L to 22 mg/L,

group C minerals: boron from 23 to 46 μg/L, chromium from 0.12 to 0.24 μg/L, cobalt from 0.12 to 0.24 μg/L, copper from 5 to 11 μg/L, iodine from 1.5 to 3.5 μg/L, lithium from 0.45 to 1.00 μg/L, manganese from 0.45 to 1.00 μg/L, molybdenum from 0.6 to 1.2 μg/L, nickel from 0.6 to 1.2 μg/L, selenium from 40 to 82 μg/L, tin from 0.45 to 1.00 μg/L, vanadium from 0.035 to 0.075 μg/L and zinc from 31 to 62 μg/L,

group D minerals: iron 6 to 12 μg/L.

For a pilsener beer the minerals might typically be added to a final concentration in the beer as follows:

group A minerals: calcium from 188 mg/L to 224 mg/L, and magnesium from 41 mg/L to 50 mg/L

group B minerals: phosphorus at least 96 mg/L, potassium from 380 mg/L to 460 mg/L, silicon at 24 mg/L to 29 mg/L, sodium at 25 mg/L to 31 mg/L and chlorine at 28 mg/L to 35 mg/L,

group C minerals: boron from 60 to 73 μg/L, chromium from 0.3 to 0.4 μg/L, cobalt from 0.3 to 0.4 μg/L, copper from 13 to 17 μg/L, iodine from 4 to 5 μg/L, lithium from 1.2 to 1.6 μg/L, manganese from 1.2 to 1.6 μg/L, molybdenum from 1.5 to 2.0 μg/L, nickel from 1.5 to 2.0 μg/L, selenium from 40 to 82 μg/L, tin from 1.2 to 1.6 μg/L, vanadium from 0.09 to 0.12 μg/L and zinc from 83 to 99 μg/L,

group D minerals: iron 16 to 19 μg/L.

For a light beer (typically, 2.5-3.5% alcohol content) the minerals might typically be added to a final concentration in the beer as follows:

group A minerals: calcium from 11 mg/L to 21 mg/L, and magnesium from 2.6 to 4.6 mg/L

group B minerals: phosphorus at least 6 mg/L, potassium from 24 mg/L to 42 mg/L, silicon at 1.5 mg/L to 2.7 mg/L, sodium at 1.5 mg/L to 2.8 mg/L and chlorine at 1.8 mg/L to 3.2 mg/L,

group C minerals: boron from 3.5 to 7 μg/L, chromium from 0.02 to 0.035 μg/L, cobalt from 0.02 to 0.035 μg/L, copper from 0.8 to 1.6 μg/L, iodine from 0.25 to 0.5 μg/L, lithium from 0.08 to 0.14 μg/L, manganese from 0.08 to 0.14 μg/L, molybdenum from 0.1 to 0.18 μg/L, nickel from 0.1 to 0.18 μg/L, selenium from 6.8 to 12 μg/L, tin from 0.08 to 0.14 μg/L, vanadium from 0.006 to 0.011 μg/L and zinc from 5 to 9.5 μg/L,

group D minerals: iron 1 to 1.8 μg/L.

For an extra light beer (typically about 1% alcohol content) the minerals might typically be added to a final concentration in the beer as follows:

group A minerals: calcium from 23 mg/L to 42 mg/L, and magnesium from 5 to 9.5 mg/L

group B minerals: phosphorus at least about 12 mg/L, potassium from 48 mg/L to 84 mg/L, silicon at 3 mg/L to 5.3 mg/L, sodium at 3.2 mg/L to 5.6 mg/L and chlorine at 3.6 mg/L to 6.3 mg/L,

group C minerals: boron from 7.5 to 14 μg/L, chromium from 0.04 to 0.07 μg/L, cobalt from 0.04 to 0.07 μg/L, copper from 1.7 to 3.2 μg/L, iodine from 0.5 to 1.0 μg/L, lithium from 0.15 to 0.3 μg/L, manganese from 0.15 to 0.3 μg/L, molybdenum from 0.2 to 0.35 μg/L, nickel from 0.2 to 0.35 μg/L, selenium from 13 to 24 μg/L, tin from 0.15 to 0.3 μg/L, vanadium from 0.012 to 0.021 μg/L and zinc from 10 to 19 μg/L,

group D minerals: iron 1 to 3.5 μg/L.

For a medium strength beer (typically, 4-5% alcohol content) the minerals might typically be added to a final concentration in the beer as follows:

group A minerals: calcium from 11 mg/L to 23 mg/L, and magnesium from 2.6 to 5 mg/L

group B minerals: phosphorus at least about 6 mg/L, potassium from 24 mg/L to 48 mg/L, silicon at 1.5 mg/L to 3 mg/L, sodium at 1.6 mg/L to 3.2 mg/L and chlorine at 6.8 mg/L to 3.6 mg/L,

group C minerals: boron from 3.5 to 8 μg/L, chromium from 0.02 to 0.04 μg/L, cobalt from 0.02 to 0.04 μg/L, copper from 0.8 to 1.8 μg/L, iodine from 0.25 to 0.5 μg/L, lithium from 0.08 to 0.15 μg/L, manganese from 0.08 to 0.15 μg/L, molybdenum from 0.1 to 0.2 μg/L, nickel from 0.1 to 0.2 μg/L, selenium from 6.8 to 13 μg/L, tin from 0.08 to 0.15 μg/L, vanadium from 0.005 to 0.012 μg/L and zinc from 5 to 10 μg/L,

group D minerals: iron 1 to 2 μg/L.

For a full strength ale (typically, 5-7% alcohol content) the minerals might typically be added to a final concentration in the beer as follows:

group A minerals: calcium from 17 mg/L to 36 mg/L, and magnesium from 3.9 to 7.8 mg/L

group B minerals: phosphorus at least about 9 mg/L, potassium from 36 mg/L to 72 mg/L, silicon at 2.2 mg/L to 4.5 mg/L, sodium at 2.4 mg/L to 4.8 mg/L and chlorine at 2.5 mg/L to 5.5 mg/L,

group C minerals: boron from 5.5 to 11.5 μg/L, chromium from 0.03 to 0.06 μg/L, cobalt from 0.03 to 0.06 μg/L, copper from 1.2 to 2.6 μg/L, iodine from 0.3 to 0.8 μg/L, lithium from 0.12 to 0.24 μg/L, manganese from 0.12 to 0.24 μg/L, molybdenum from 0.15 to 0.3 μg/L, nickel from 0.15 to 0.3 μg/L, selenium from 10 to 21 μg/L, tin from 0.12 to 0.24 μg/L, vanadium from 0.009 to 0.02 μg/L and zinc from 7.5 to 16 μg/L,

group D minerals: iron 1.5 to 3 μg/L.

The mineral additives preferably has elements present in certain proportions by element weight as follows:

group A; calcium from 25 to 82 and magnesium from 6 to 18,

group B; potassium from 50 to 180, silicon from 0.45 to 1.5, sodium from 3 to 30, chlorine from 3 to 28,

group C; boron from 0 to 0.060, chromium from 0 to 0.0005, cobalt from 0 to 0.0005, copper from 0 and 0.012, iodine from 0 to 0.006, lithium from 0 to 0.0015, manganese from 0 to 0.0015, molybdenum from 0 to 0.0015, nickel from 0 to 0.0005, selenium from 0 to 0.100, tin from 0 to 0.0015, vanadium from 0 to 0.1 and zinc from 0 and 0.100,

group D: Iron from 0 to 0.020,

A preferred range of proportions of the group A elements in the mineral additive preparation are as follows, calcium from 44 to 74 and magnesium from 10 to 16. The most preferable proportion of calcium is about 59 and the most preferable proportion of magnesium is about 13.

A preferred range of proportions of the group B elements in the mineral additive preparation are as follows; potassium from 80 to 150, silicon from 0.55 to 1.0, sodium from 5 to 15, chlorine from 5 to 14.

A most preferred proportion of each group B element is as follows; potassium is about 120, silicon is about 0.75, sodium is about 8, and chlorine is about 9 mg/L.

A preferred range of proportion of the group C elements in the mineral additive preparation are as follows; boron from 0.010 to 0.040, chromium from 0.00005 to 0.0002, cobalt from 0.00005 to 0.0002, copper from 2 to 9, iodine from 0.0004 to 0.0025, lithium from 0.0001 to 0.0010, manganese from 0.0001 to 0.0010, molybdenum from 0.0001 to 0.0010, nickel from 0.00005 to 0.0002, selenium from 0.010 to 0.070, tin from 0.0001 to 0.0010, vanadium from 0.00001 to 0.00007 and zinc from 0.010 to 0.070.

A most preferred proportion of each group C element is as follows; boron is about 0.019, chromium is about 0.0001, cobalt is about 0.0001, copper is about 0.0043, iodine is about 0.0013, lithium is about 0.0004, manganese is about 0.0004, molybdenum is about 0.0005, nickel is about 0.0001, selenium is about 0.034, tin is about 0.0004, vanadium is about 0.00003 and zinc is about 0.026.

A preferred range of proportions the group D element present in the mineral additive preparation is as follows: iron is from 0.002 to 0.012, and most preferably about 0.005.

It might be desired to add only group A and B elements and these may be added at to their preferred or most preferred levels, and perhaps also added by way of an additive in their preferred or most preferred proportions. All or some of the group C and D elements may also be added. Those elements from group C and D that are more preferred to be present are boron, copper, iodine, selenium, zinc and iron.

Preferably the mineral additive is made up as separate aqueous preparations of the group A, B, C and D minerals. These could be added separately to the beer or perhaps as two or more preparations combined such as perhaps groups A and B combined or perhaps C and D combined or A alone and B, C and D combined.

Alternatively the mineral additive is prepared by first making a preparation of group A minerals followed by the addition of the minerals of the other groups.

The pH of the preparation is of importance because the pH of beer is an important characteristic. It is preferred that any buffer or acid is added to the group A minerals either as a separate preparation or before the addition of other mineral to make up a combined preparation. Alternatively buffer may be added to one or more of the preparations B, C and D separately or combined in addition to being added to group A.

The pH is adjusted preferably in the range of 3.5 through to 5.0 and preferably no higher than 4.7. More preferably the pH is about 3.8 to about 4.5.

Where the pH of a preparation of either the group A minerals or the mineral additive preparation is brought below about 4.5, 4.4, 4.3, 4.3, 4.1 or 4.0 it is preferred that the suspension of Ca and Mg is brought into solution. Addition of carbon dioxide might be used where the pH is sought to be brought to a level of about 4.2 to 4.4 or greater. This is particularly the case when using a range of concentrations of calcium of up to about 100 mg/L or 240 mg/L. Where it is desired to use a preparation more concentrated, carbon dioxide does not provide sufficient buffering capacity under reasonable working pressures to bring the pH down to the above levels. Organic or mineral acids might be utilized instead. Thus citric, lactic, malic, tartaric, fumaric or other organic acids might be used. These may be somewhat undesirable because they have a tendency, when added in significant amounts, to impact on the taste of the final beer. A taste neutral mineral acid is preferable. For example phosphoric acid is a suitable acid being generally approved for food use. Other mineral acids, such as sulphuric acid or hydrochloric acid may be used but they impact more substantially on taste than phosphoric acid.

The use of phosphoric acid has the additional benefit when used for dilution of the group A concentrate, in that it presents the calcium and magnesium as soluble phosphate compound. Additionally when phosphoric acid or other mineral acid is used this permits more ready use of calcium and magnesium as carbonates rather than hydroxides as sources of these minerals and that has benefits, if only from cost point of view. In particular where the pH of the group A mineral preparation is to be adjusted to a pH of about 4 then the difficulty presented by the use of a suspension of the calcium and magnesium compounds is obviated because these are readily solubilised at the level of acid required in the case of phosphoric acid and hydrochloric acid.

It may additionally be desired not to buffer only the group A mineral preparation. It might thus for example be desired to add sufficient acid to the group A mineral preparation to bring the calcium and magnesium compounds into solution. The remainder of the acid might be added to either one or more of the preparations of group B, C and D elements when separate or combined.

The concentration of the minerals in the mineral additive preparation will depend very much on the desired final concentration of the minerals, the level of dilution of the beer that is required, and at higher concentrations the capacity to make preparations of a particular strength.

Dilution in at one end of the spectrum might be as high as about 90% for example to produce a 0.5% alcohol beer, however typically it will however not be more than about 50%. The dilution might be less than 50% in particular when the wort used has relatively low fermentability, or its alcohol content is lower than that usually used to manufacture a full-strength beer. Dilution of such beers might be in the range of 5-50%. Alternatively the dilution might be less still where, for example, a highly concentrated or dry preparation of the minerals is to be added simply to improve the taste of a full strength beer.

Addition of the mineral additive preparation might be in two broad alternative forms. In a first form the additive might be added as a relatively dilute form, particularly where the required dilution of the beer is high. The mineral additive preparations in such first form is added to the base beer before gassing with carbon dioxide and perhaps final adjustment for pH and preferably deaerated.

In a second form the additive may be added in concentrated form relative to the final concentration in the beer, perhaps as much as 200 fold. In this second form the mineral additive is preferably added after the base beer has been diluted with water (or not), gassed and adjusted for pH. The mineral additive preparation or preparations will have its pH adjusted to coincide with that of the final beer and will be deaerated, so that it does not disturb the generally anoxic condition of the beer. This second form may additionally entail addition of one or more of the minerals in dry form.

The choices of biologically acceptable salts for each of the elements are wide and might be any of those that are acceptable for human consumption at the levels indicated. Biologically acceptable salts refer to salts of the minerals concerned that have no adverse effects on ingestion or afterwards at the levels in the beverage, and these levels will vary for each element.

There are some quite strong preferences in the source of the elements that form part of the invention. These are provided as a soluble salt and are thus provided with other elements which other elements must not be in a form that provides imbalances to the final composition or interferes with the manufacturing process. Preferably elements are maintained in a form capable of impacting on taste, thus the salts in which the elements are provided should be intercompatible and not, for example, complexed into forms that are unavailable for taste perception. Also there should be no other components that provide for significant adverse taste or health effects.

Calcium is most preferably provided or partially provided in the form of calcium hydroxide Ca(OH)₂. This is initially provided as a suspension particularly where it is provided as a concentrate. The preferred adjustment for pH is by the addition of CO₂ (carbon dioxide), which addition then converts the calcium hydroxide to calcium bicarbonate which is soluble Ca(OH)₂+2 CO₂->Ca(HCO₃)₂. Calcium hydroxide is preferably added as the primary or sole source of calcium. Other sources of calcium might also be used but these are not preferred and if used should be used as part only of the source of calcium. Thus some of the calcium might be added as CaCl₂ (calcium chloride) however this cannot be used as the sole source of calcium because the levels of calcium required would result an excess of chlorine. CaI₂ (calcium iodine) might be used as a partial source of calcium but not the sole source because otherwise an excess of iodine is provided. CaSO₄ (calcium sulphate) might be used as a partial source however not the sole source because an excess of sulphur would result in an adverse taste characteristic. Ca(H₂PO₄)₂ (monobasic calcium phosphate) might be used as a partial but not sole source, otherwise an excess of phosphorus would be provided, solubility issues arise and additionally an unacceptable risk of reaction with the preferred silicon source (SiO₃²⁻) would result. Calcium carbonate may also be used as a calcium source if a mineral acid is used to adjust the pH of the beer lower than about 5.

Magnesium is preferably provided or partially as Mg(OH)₂ (magnesium hydroxide) which as with the calcium counterpart above is insoluble but can be provided in suspension in concentrated form and is converted to Mg(HCO₃)₂ (magnesium bicarbonate) when the pH is adjusted by the addition of CO₂. Magnesium hydroxide is preferably added as the primary or sole source of magnesium. Other sources of magnesium might also be used but these are not preferred and may be used as part only of the source of magnesium. Thus MgCl₂ (magnesium chloride) might be added as a partial but not sole source because at the concentrations for providing the required level of magnesium chlorine would be provided in excess. Mg(H₂PO₄)₂ (monobasic magnesium phosphate) may also provide as a partial but not complete source of magnesium for reasons similar to why calcium cannot be provided solely in this form. MgSeO₄ (magnesium selenate) may be a partial but not sole source of magnesium because at the concentrations for providing the required level of magnesium selenium would be provided in excess. MgSO₄ (magnesium sulphate) may be a partial but not sole source of magnesium because at the required levels of magnesium an excess of sulphur, with its adverse taste characteristics, would result. Magnesium carbonate may also be used as a magnesium source if a mineral acid is used to adjust the pH of the beer lower than about 5.

Phosphorus might be provided solely or partially in the form of KH₂PO₄ (monobasic potassium phosphate) or alternatively or additionally in part by NaH₂PO₄ (monobasic sodium phosphate), the latter compound could lead to excessive levels of sodium at the concentration required if it were the sole source of phosphorus. K₂HPO₄ (dibasic potassium phosphate) may also be a partial source of phosphorus but care must be taken with the levels of potassium provided and a difficulty may be found in the handling of the compound because it is hygroscopic. Phosphorous might be additionally provided in the form of H₃PO₄ (Phosphoric Acid).

Potassium can be provided solely or partially in the form of KH₂PO₄ (monobasic potassium phosphate) or KHCO₃ (potassium bicarbonate). KCl (potassium chloride) may be a partial but not sole source of potassium because at the concentrations for providing the required level of potassium chlorine would be provided in excess. KI (potassium iodide) may be a partial but not sole source of potassium because at the concentrations for providing the required level of potassium iodine would be provided in excess. K₂MoO₄.5H₂O (potassium molybdate) may be used as a partial source of potassium, but the ease of use of this compound is complicated because it is a deliquescent powder and also excess molybdenum should be avoided. K₂HPO₄ (dibasic potassium phosphate) may also be a partial source of potassium however care must be taken with the levels of phosphorus provided and a difficulty may be found in the handling of the compound because it is hygroscopic. K₂SeO₄ (potassium selenate) may also be a partial source of potassium but its use is limited by the level of selenium that is acceptable. K₂SO₄ (potassium sulphate) might also be used as a partial source of potassium, the level being limited by the tolerated level of sulphur.

Silicon is preferably provided as Na₂SiO₃.5H₂O (sodium metasilicate).

There are a number of potential sources of sodium including NaHCO₃ (sodium bicarbonate) Na₂B₄O₇.10H₂O (sodium tetraborate), NaCl (sodium chloride), Na₂MoO₄.2H₂O (sodium molybdate), Na₂SeO₄.10H₂O (sodium selenate), Na₂SeO₃ (sodium selenite) Na₂SiO₃.5H₂O (sodium silicate) and Na₂SO₄ or Na₂SO₄.10H₂O (sodium sulphate). Sodium is commonly found in salts used for other elements central to the formulation of the present composition so that whilst some of the above compounds may be suitable to solely supply the sodium it is anticipated that two or more of these compounds will collectively provide the requisite level of sodium perhaps also in combination with other sources. In addition to the above, less preferable sources of sodium include NaH₂PO₄.H₂O or 2H₂O (monobasic sodium phosphate) and Na₂HPO₄.7H₂O (dibasic sodium phosphate).

There are also a large range of salts that might provide chlorine and these might include NaCl (sodium chloride), KCl (potassium chloride), CaCl₂ (calcium chloride) or MgCl₂ (magnesium chloride).

Boron is preferably provided in the form Na₂B₄O₇.10H₂O (sodium tetraborate) but might be provided as K₂B₄O₇.5H₂O (potassium tetraborate).

Chromium is preferably provided in the form K[Cr(SO₆H₄)₂(H₂O)₂].6H₂O (chromium potassium sulphate) which thus also will contribute as a source of potassium.

Cobalt is preferably provided as either CoK₂(SO₄)₂.6H₂O (cobaltous potassium sulphate) or CoSO₄.7H₂O (cobalt sulphate).

Copper is preferably provided in the form of CuSO₄.5H₂O (cupric sulphate) but might be provided as CuSeO₄.5H₂O (cupric selenate).

Iodine is preferably provided as (KI) potassium iodide.

Lithium is preferably provided in the form Li₂SO₄.H₂O (lithium sulphate) and this is preferably the sole source of lithium. Alternatively or additionally lithium might be added as LiCl (lithium chloride) but this compound is deliquescent and therefore must be handled accordingly. Lithium might be also added as Li₂SeO₄.H₂O (lithium selenate).

Manganese is preferably added in the form of MnSO₄.H₂O (manganous sulphate) but may be provided perhaps in part in the form of MnCl₂.4H₂O (manganous chloride).

Molybdenum is preferably added in the form of Na₂MoO₄.2H₂O (sodium molybdate) but may also be provided perhaps in part in the form of K₂MoO₄.5H₂O (potassium molybdate) the latter is however deliquescent and therefore must be handled accordingly.

Nickel is preferably added in the form NiSO₄.6H₂O (nickel sulphate) but may also be provided perhaps in part in the form NiCl₂.6H₂O (nickel chloride) the latter is however deliquescent and therefore must be handled accordingly.

Selenium is preferably added in the form Na₂SeO₄.10H₂O (sodium selenate), K₂SeO₄ (potassium selenate), MgSeO₄ (magnesium selenate) or Na₂SeO₃ (sodium selenite).

Tin is preferably added as SnCl₂.2H₂O (stannous chloride).

Vanadium is preferably added in the form of NH₄VO₃ (ammonium vanadate).

Zinc is preferably added as ZnSO₄.H₂O or ZnSO₄.7H₂O (zinc sulphate).

Iron is preferably added as FeSO₄.7H₂O (ferrous sulphate). Less preferably FeCl₂ or FeCl₂.2H₂O (ferrous chloride) might also be used; the former being hygroscopic and the latter being somewhat unstable.

It is found that the preferred compounds do not adversely complex or interfere chemically with other compounds among the components. Thus where adverse strong complexes are formed between the component minerals or where adverse reactions take place between the component parts there is a strong likelihood that the minerals may be present in a form that will not contribute to the taste profile and may produce undesirable taste characteristics.

### DETAILED DESCRIPTION OF EXEMPLIFIED EMBODIMENTS OF THE INVENTION

### Example 1

Preparative Techniques

Preparation of Separate Group A, B, C and D Elements

The group A elements are prepared separately by suspension in purified water (B.P. grade pure water (double distilled deionized filtered)) of calcium hydroxide Ca(OH)₂ or calcium carbonate CaCO₃ and magnesium hydroxide Mg(OH)₂ or magnesium carbonate MgCO₃ in proportions of Ca:Mg required in the mineralized diluent water or in the concentrate added to finished beers. The group A concentrate preparation takes the form of a suspension. Commercially available calcium hydroxide and magnesium hydroxide may contain insoluble carbonates. These are best removed by filtering the solution of group A after addition of CO₂ or by filtering the final solution. A final solution of group A minerals requires a reactive step to achieve a solution which may produce a precipitate if mixed with B, C and D at certain concentrations and pH levels. The nature of the reactions will depend on the starting constituents and the buffer that is added and may be as follows.
Ca(OH)₂+2CO₂->Ca(HCO₃)₂ i)
Mg(OH)₂+2CO₂->Mg(HCO₃)₂ ii)
CaCO₃+CO₂+H₂O->Ca(HCO₃)₂ iii)
MgCO₃+CO₂+H₂O->Mg(HCO₃)₂ iv)
Ca(HCO₃)₂+H₃PO₄->CaHPO₄+2CO₂+2H₂O v)
Mg(HCO₃)₂+H₃PO₄->MgHPO₄+2CO₂+2H₂O vi)
Ca(OH)₂+H₃PO₄->CaHPO₄+2H₂O vii)
Mg(OH)₂+H₃PO₄->MgHPO₄+2H₂O viii)
CaCO₃+H₃PO₄->CaHPO₄+H₂O+CO₂ ix)
MgCO₃+H₃PO₄->MgHPO₄+H₂O+CO₂ x)

Thus for example as set out in reactions v) and vi), above, to achieve a solution of the calcium and magnesium a relatively dilute bicarbonate solution can be prepared by reaction with carbon dioxide either as an introduced gas or an introduced solid. Most preferably this is as set out for reactions (i) and (ii) and less preferably, although it is still feasible, using reactions (iii) and (iv) because the hydroxides are more reactive with dissolved carbon dioxide. The buffer might therefore be added to the solutions resulting from reactions (i) through iv) to reflect the reactions set out in (v) and (vi) to partially or completely convert bicarbonates to monohydrogen phosphates or the buffer may be added to the suspension of either hydroxides or carbonates as in reactions (vii) through (x). The latter four reactions could produce a range of solutions from relatively dilute mineral water containing buffer to concentrates.

A typical mineralized diluent solution of group A may be prepared by suspending 5.46 g of Ca(OH)₂ and 1.63 g of (Mg(OH)₂ per litre of water and reaction. 20 ml of the suspension is diluted to 900 ml of water with CO₂ to produce a clear solution of calcium and magnesium bicarbonates. The resulting solution of group A contains (Ca) 66.7 mg/L and (Mg) 15.1 mg/L.

A typical more concentrated solution of group A may be prepared by mixing 7.37 g of CaCO₃ and 2.36 g of MgCO₃ and 9.96 g of H₃PO₄ (added as a concentrated acid) per litre of water. After reaction the solution of group A contains (Ca) 3000 mg/L and (Mg) 680 mg/L.

Any addition of phosphoric acid buffer required in the finished product can be added to either the mineralized diluent or more concentrated form of group A as required by experimentation to achieve the desired pH in the treated beer. Typically about 5 to 15 g of H₃PO₄ is required per litre of concentrate (see above) or about 0.1 to 0.75 g of H₃PO₄ per litre of mineralized diluent water depending upon the underlying chemical properties of the treated beer and desired endpoint pH.

The group B elements are prepared as a solution in purified water using the following salts:

Monobasic potassium phosphate (KH₂PO₄)

Potassium bicarbonate (KHCO₃)

Sodium metasilicate (Na₂SiO₃.5H₂O)

Sodium bicarbonate (NaHCO₃)

Sodium chlorine (NaCl)

The quantities of these salts are added so that the group B solution contains the elements phosphorus, potassium, silicon, sodium and chlorine in the proportions required in the mineralized diluent water or concentrated preparation of group B. In the preparation of this solution some proportion of KHCO₃ and NaHCO₃ undergo the reactions KHCO₃+KH₂PO₄->K₂HPO₄+H₂O+CO₂ and 2NaHCO₃+2KH₂PO₄->Na₂HPO₄+K₂HPO₄+2H₂O+2CO₂. The concentrated group B preparation takes, in part, the form of a stable colloid once the silicate is added.

A typical concentrate of group B can be prepared by dissolving 20 g of KH₂PO₄, 2 g of NaCl, 0.4 g of NaHCO₃, 0.7 g of Na3SiO₃.5H₂O and 34 g of KHCO₃ per litre of water. This concentrate can be added directly to beer.

8 ml of concentrate per litre of beer adds 3.64 mg/L phosphorous, 9.7 mg/L chlorine, 8.4 mg/L sodium, 0.9 mg/L silicon and 141 mg/L potassium. Alternatively 8 ml of concentrate could be added per litre to a group A mineralized diluent solution to construct a combined group A and B mineralized diluent water with the same resulting addition of elements of group B above.

The group C elements are prepared in a single solution in purified water using the following salts:

| | |
|---|---|
| Sodium Tetraborate¹ | Na₂B₄O₇•10H₂O |
| Chromium Potassium Sulphate^{2,3} | K[Cr(SO₆H₄)₂(H₂O)₂]•6H₂O |
| Cobalt Sulphate³ | CoSO₄•7H₂O |
| Cupric Sulphate³ | CuSO₄•5H₂O |
| Potassium Iodide² | KI |
| Lithium Sulphate³ | Li₂SO₄•H₂O |
| Manganous Sulphate³ | MnSO₄•H₂O |
| Sodium Molybdate¹ | Na₂MoO₄•H₂O |
| Nickel Sulphate³ | NiSO₄•6H₂O |
| Sodium Selenate¹ | Na₂SeO₄•10H₂O |
| Stannous Chloride⁴ | SnCl₂•H₂O |
| Ammonium Vanadate⁵ | NH₄VO₃ |
| Zinc Sulphate³ | ZnSO₄•7H₂O |

Notes
¹Sodium is added in (C) in addition to (B). This should be allowed for by either adjusting (B) or adjusting final sodium concentration to allow for sodium in (C). Note (C) adds μg levels as compared to mg levels in (B).
²Potassium is added in (C) in addition to (B). This should be allowed for by either adjusting (B) or adjusting final potassium concentration to allow for potassium in (C). Note (C) adds μg levels as compared to mg levels in (B).
³The final concentration of sulphate anion (SO₄²⁻) is determined by the concentrations of Cr⁺⁺, Co⁺⁺, Cu⁺⁺, Li⁺⁺, Mn⁺⁺, Ni⁺⁺ and Zn⁺⁺ in the mineralized drinking water.
⁴Chloride is added in (C) in addition to (B). This should be allowed for by either adjusting (B) or adjusting final chloride concentration to allow for chloride in (C). Note (C) adds μg levels as compared to mg levels in (B).
⁵Only very small amounts of nitrogen are present as ammonium NH₄⁺ cation.

A typical concentrate of group C may be prepared by dissolving per litre of solution 86.5 mg of sodium tetraborate, 0.70 mg of chromium potassium sulphate, 0.23 mg of Cobalt sulphate, 8.67 mg of cupric sulphate, 0.77 mg of potassium iodide, 4.52 mg of lithium sulphate, 0.60 mg of manganese sulphate, 0.62 mg of sodium molybate, 0.22 mg of nickel sulphate, 35.2 mg of sodium selenate, 0.92 mg of stannous chloride, 0.06 mg of ammonium vanadate, and 64.7 mg of zinc sulphate.

This concentrated can be added directly to beer. 2 ml of concentrate per litre of beer adds 20 μg of boron, 0.15 μg of chromium, 0.1 μg of cobalt, 4.5 μg of copper, 1.2 μg of iodine, 0.50 μg of lithium, 0.4 μg of manganese, 0.5 μg of molybdenum, 0.1 μg of nickel, 30 μg of selenium, 0.4 μg of tin, 0.05 μg of vanadium, and 30 μg of zinc.

Alternatively 2 ml of concentrate could be added per litre to a group A mineralized diluent water to construct a combined group A and C mineralized diluent water with the same resulting addition of elements of group C as above.

The group A, B, and C preparations can be premade and stored separately.

The group D element is made up freshly as a solution in purified water as FeSO₄.7H₂O (ferrous sulphate) which is prepared additionally and separately from C to avoid ferric cations, resulting from oxidation of ferrous cations (Fe⁺⁺->Fe⁺⁺⁺), contaminating solution C or deteriorating solution D. Ferrous sulphate may be added directly to base solution (C) for later use if oxidation can be prevented or it may be added immediately to make up the beverage. The ferrous sulphate is also preferably filtered prior to use to remove any insoluble ferric complexes that might be present in commercial sources. Please note: Note 3 above about (SO₄²⁻) also applies.

A typical concentrate of group D can be prepared by dissolving per litre of solution 14.6 mg of ferrous sulphate heptahudrate. This concentrate can be added directly to beer. 2 ml of concentrate per litre of beer adds 6 μg/L of iron. Alternatively 2 ml of concentrate can be added per litre to a group A mineralized diluent water to construct a combined group A and D mineralized diluent water with an iron concentration of 6 μg/L.

A typical mineralized diluent water containing groups A, B C and D could be constructed by adding to the above example of group A (900 ml) 8 ml of group B concentrate, 2 ml of group C concentrate and 2 ml of group D concentrate and 88 ml of water. The resulting concentrations of group A elements would be reduced to 60 mg/L (Ca) and 13.6 mg/L (Mg) and the concentrations of the group B, C and D elements would be the same as the amounts added respectively per litre of beer above.

Mineralized diluent waters with more or less concentration of constituent elements may be constructed by increasing of decreasing proportionately the concentration of calcium and magnesium salts in the initial group A suspension and adding proportionally more or less concentrates of groups B, C and D to maintain the desired proportions of all constituent elements.

A mineralized diluent water constructed from a group A solution generated with CO₂ to which are added concentrates of groups B, C and D would be expected to have a higher pH than the beer in which it would be a diluent. Therefore buffering acid would be added to the diluted beer or could be diluted out at a previously determined amount to the mineralized diluent water prior to diluting the base beer.

The pH of the final prepared mineralized diluent water is at the preferred level which is pH of between 3.8 to 4.5.

### Example 2

Modification of Flavors of Various Beers

In each case a range of strengths of the diluent water were added to the beers to ascertain a level of addition that gave the most favorable result.

James Squire Original Pilsener

Modified beers made by adding per litre 3.2 and 3.8 times the preparations of A, B, C and D described in example 1 and 0.07 g/L of phosphoric acid buffer were superior to the unmodified pilsener beer. They had a reduced aftertaste bitterness on the tongue combined with more intense expression of flavors and even more approachable for drinking. The next preferred level of addition of concentrates was 3.6 times the strength of example 1.

Southwark Old Stout.

Modified beers made by adding per litre 1.2 to 2.4 times the concentration of the strength of the preparations of A, B, C and D described in Example 1 and 0.035 g/L of phosphoric acid buffer were more approachable and had a breader flavor profile and reduced sharpness on the palate compared with the unmodified stout beers. The most preferred level of addition of concentrates was 1.5 times the strength of example 1.

West End Draught Beer

Modified beers made by adding per litre 0.2 to 0.3 times the concentration of A, B, C and D described in example 1 and 0.004 g/L of phosphoric acid buffer were more approachable because the modification reduced the influence of an ester component in the taste profile and exposed more malt flavor components. The most preferred level of addition of concentrates was 0.25 times the strength of example 1.

A Light Beer (2.7% Alcohol)

A rage of light beers were constructed by diluting a full strength beer (5%) with mineralized diluent waters. Waters with 1.8 to 2.0 times the concentration of Example 1 and 0.02 g/L of phosphoric acid buffer were superior to light beers constructed using BP standard pure water as a diluent. The modified beers had enhanced aroma enhanced flavor profiles and greater length on the palate. The most preferred diluent was 1.9 times the strength of example 1. Diluting full strength beers with BP (pure) water has the general effect of reducing aroma, reducing flavor and taste sensation, introduces a watery aftertaste with associated loss of retention of flavors in the palate.

1. A method of enhancing the taste of a beer with a mineral additive, the mineral additive including soluble compounds of the following minerals to the following ranges of final concentrations of the respective element in the finished beer, to enhance taste characteristics of the diluted beer when compared to a dilution solely with water:
group A minerals: calcium from 5.9 mg/L to 236 mg/L, and magnesium from 1.3 to 52 mg/L
group B minerals: phosphorus from 3.0 to 360 mg/L, potassium from 12 mg/L to 480 mg/L, silicon at 0.075 mg/L to 30 mg/L, sodium at 0.8 mg/L to 32 mg/L and chlorine at 0.9 mg/L to 36 mg/L,
group C minerals: boron from 0 to 76 μg/L, chromium from 0 to 0.4 μg/L, cobalt from 0 to 0.4 μg/L, copper from 0 to 17.2 μg/L, iodine from 0 to 5.2 μg/L, lithium from 0 to 1.6 μg/L, manganese from 0 to 1.6 μg/L, molybdenum from 0 to 2.0 μg/L, nickel from 0 to 2.0 μg/L, selenium from 0 to 136 μg/L, tin from 0 to 01.6 μg/L, vanadium from 0 to 0.12 μg/L and zinc from 0 to 104 μg/L,
group D minerals: iron 0 to 20 μg/L.

2. The method of enhancing the taste of a beer with a mineral additive according to claim 1 including diluting of the base beer with the addition of water, the base beer being diluted to between 0.5% and 90% of its original strength.

3. The method of enhancing the taste of a beer with a mineral additive according to claim 1 wherein at least some of the minerals of groups A,. B, C and D are added in dry form.

4. The method of enhancing the taste of a beer with a mineral additive according to claim 1 wherein the finished beer is a stout beer and the minerals are added to a final concentration in the finished beer as follows:
group A minerals: calcium from 70 mg/L to 143 mg/L, and magnesium from 15 mg/L to 32 mg/L
group B minerals: phosphorus at least 36 mg/L, potassium from 144 mg/L to 288 mg/L, silicon at 9 mg/L to 18 mg/L, sodium at 9 mg/L to 20 mg/L and chlorine at 11 mg/L to 22 mg/L,
group C minerals: boron from 23 to 46 μg/L, chromium from 0.12 to 0.24 μg/L, cobalt from 0.12 to 0.24 μg/L, copper from 5 to 11 μg/L, iodine from 1.5 to 3.5 μg/L, lithium from 0.45 to 1.00 μg/L, manganese from 0.45 to 1.00 μg/L, molybdenum from 0.6 to 1.2 μg/L, nickel from 0.6 to 1.2 μg/L, selenium from 40 to 82 μg/L, tin from 0.45 to 1.00 μg/L, vanadium from 0.035 to 0.075 μg/L and zinc from 31 to 62 μg/L,
group D minerals: iron 6 to 12 μg/L.

5. The method of enhancing the taste of a beer with a mineral additive according to claim 1 wherein the finished beer is a pilsener beer and the minerals are added to a final concentration in the finished beer as follows:
group A minerals: calcium from 188 mg/L to 224 mg/L, and magnesium from 41 mg/L to 50 mg/L
group B minerals: phosphorus at least 96 mg/L, potassium from 380 mg/L to 460 mg/L, silicon at 24 mg/L to 29 mg/L, sodium at 25 mg/L to 31 mg/L and chlorine at 28 mg/L to 35 mg/L,
group C minerals: boron from 60 to 73 μg/L, chromium from 0.3 to 0.4 μg/L, cobalt from 0.3 to 0.4 μg/L, copper from 13 to 17 μg/L, iodine from 4 to 5 μg/L, lithium from 1.2 to 1.6 μg/L, manganese from 1.2 to 1.6 μg/L, molybdenum from 1.5 to 2.0 μg/L, nickel from 1.5 to 2.0 μg/L, selenium from 40 to 82 μg/L, tin from 1.2 to 1.6 μg/L, vanadium from 0.09 to 0.12 μg/L and zinc from 83 to 99 μg/L,
group D minerals: iron 16 to 19 μg/L.

6. The method of enhancing the taste of a beer with a mineral additive according to claim 1 wherein the finished beer is a light beer and the minerals are added to a final concentration in the finished beer as follows:
group A minerals: calcium from 11 mg/L to 21 mg/L, and magnesium from 2.6 to 4.6 mg/L
group B minerals: phosphorus at least 6 mg/L, potassium from 24 mg/L to 42 mg/L, silicon at 1.5 mg/L to 2.7 mg/L, sodium at 1.5 mg/L to 2.8 mg/L and chlorine at 1.8 mg/L to 3.2 mg/L,
group C minerals: boron from 3.5 to 7 μg/L, chromium from 0.02 to 0.035 μg/L, cobalt from 0.02 to 0.035 μg/L, copper from 0.8 to 1.6 μg/L, iodine from 0.25 to 0.5 μg/L, lithium from 0.08 to 0.14 μg/L, manganese from 0.08 to 0.14 μg/L, molybdenum from 0.1 to 0.18 μg/L, nickel from 0.1 to 0.18 μg/L, selenium from 6.8 to 12 μg/L, tin from 0.08 to 0.14 μg/L, vanadium from 0.006 to 0.011 μg/L and zinc from 5 to 9.5 μg/L,
group D minerals: iron 1 to 1.8 μg/L.

7. The method of enhancing the taste of a beer with a mineral additive according to claim 1 wherein the finished beer is an extra light beer and the minerals are added to a final concentration in the finished beer as follows:
group A minerals: calcium from 23 mg/L to 42 mg/L, and magnesium from 5 to 9.5 mg/L
group B minerals: phosphorus at least about 12 mg/L, potassium from 48 mg/L to 84 mg/L, silicon at 3 mg/L to 5.3 mg/L, sodium at 3.2 mg/L to 5.6 mg/L and chlorine at 3.6 mg/L to 6.3 mg/L,
group C minerals: boron from 7.5 to 14 μg/L, chromium from 0.04 to 0.07 μg/L, cobalt from 0.04 to 0.07 μg/L, copper from 1.7 to 3.2 μg/L, iodine from 0.5 to 1.0 μg/L, lithium from 0.15 to 0.3 μg/L, manganese from 0.15 to 0.3 μg/L, molybdenum from 0.2 to 0.35 μg/L, nickel from 0.2 to 0.35 μg/L, selenium from 13 to 24 μg/L, tin from 0.15 to 0.3 μg/L, vanadium from 0.012 to 0.021 μg/L and zinc from 10 to 19 μg/L,
group D minerals: iron 1 to 3.5 μg/L.

8. The method of enhancing the taste of a beer with a mineral additive according to claim 1 wherein the finished beer is a medium strength beer and the minerals are added to a final concentration in the finished beer as follows:
group A minerals: calcium from 11 mg/L to 23 mg/L, and magnesium from 2.6 to 5 mg/L
group B minerals: phosphorus at least about 6 mg/L, potassium from 24 mg/L to 48 mg/L, silicon at 1.5 mg/L to 3 mg/L, sodium at 1.6 mg/L to 3.2 mg/L and chlorine at 6.8 mg/L to 3.6 mg/L,
group C minerals: boron from 3.5 to 8 μg/L, chromium from 0.02 to 0.04 μg/L, cobalt from 0.02 to 0.04 μg/L, copper from 0.8 to 1.8 μg/L, iodine from 0.25 to 0.5 μg/L, lithium from 0.08 to 0.15 μg/L, manganese from 0.08 to 0.15 μg/L, molybdenum from 0.1 to 0.2 μg/L, nickel from 0.1 to 0.2 μg/L, selenium from 6.8 to 13 μg/L, tin from 0.08 to 0.15 μg/L, vanadium from 0.005 to 0.012 μg/L and zinc from 5 to 10 μg/L,
group D minerals: iron 1 to 2 μg/L.

9. The method of enhancing the taste of a beer with a mineral additive according to claim 1 wherein the finished beer is a full strength beer and the minerals are added to a final concentration in the finished beer as follows:
group A minerals: calcium from 17 mg/L to 36 mg/L, and magnesium from 3.9 to 7.8 mg/L
group B minerals: phosphorus at least about 9 mg/L, potassium from 36 mg/L to 72 mg/L, silicon at 2.2 mg/L to 4.5 mg/L, sodium at 2.4 mg/L to 4.8 mg/L and chlorine at 2.5 mg/L to 5.5 mg/L,
group C minerals: boron from 5.5 to 11.5 μg/L, chromium from 0.03 to 0.06 μg/L, cobalt from 0.03 to 0.06 μg/L, copper from 1.2 to 2.6 μg/L, iodine from 0.3 to 0.8 μg/L, lithium from 0.12 to 0.24 μg/L, manganese from 0.12 to 0.24 μg/L, molybdenum from 0.15 to 0.3 μg/L, nickel from 0.15 to 0.3 μg/L, selenium from 10 to 21 μg/L, tin from 0.12 to 0.24 μg/L, vanadium from 0.009 to 0.02 μg/L and zinc from 7.5 to 16 μg/L,
group D minerals: iron 1.5 to 3 μg/L.

10. The method of enhancing the taste of a beer with a mineral additive according to claim 1 wherein the mineral additive has elements present in certain proportions by element weight as follows:
group A; calcium from 25 to 82 and magnesium from 6 to 18,
group B; potassium from 50 to 180, silicon from 0.45 to 1.5, sodium from 3 to 30, chlorine from 3 to 28,
group C; boron from 0 to 0.060, chromium from 0 to 0.0005, cobalt from 0 to 0.0005, copper from 0 and 0.012, iodine from 0 to 0.006, lithium from 0 to 0.0015, manganese from 0 to 0.0015, molybdenum from 0 to 0.0015, nickel from 0 to 0.0005, selenium from 0 to 0.100, tin from 0 to 0.0015, vanadium from 0 to 0.1 and zinc from 0 and 0.100,
group D: Iron from 0 to 0.020,

11. The method of enhancing the taste of a beer with a mineral additive according to claim 10 wherein a range of proportions of the group A elements in the mineral additive preparation are as follows, calcium from 44 to 74 and magnesium from 10 to 16.

12. The method of enhancing the taste of a beer with a mineral additive according to claim 11 wherein the proportion of calcium is about 59 and the most preferable proportion of magnesium is about 13.

13. The method of enhancing the taste of a beer with a mineral additive according to claim 10 wherein a range of proportions of the group B elements in the mineral additive preparation are as follows; potassium from 80 to 150, silicon from 0.55 to 1.0, sodium from 5 to 15, chlorine from 5 to 14.

14. The method of enhancing the taste of a beer with a mineral additive according to claim 13 wherein the proportion of each group B element is as follows; potassium is about 120, silicon is about 0.75, sodium is about 8, and chlorine is about 9 mg/L.

15. The method of enhancing the taste of a beer with a mineral additive according to claim 10 wherein a range of proportions of the group C elements in the mineral additive preparation are as follows; boron from 0.010 to 0.040, chromium from 0.00005 to 0.0002, cobalt from 0.00005 to 0.0002, copper from 2 to 9, iodine from 0.0004 to 0.0025, lithium from 0.0001 to 0.0010, manganese from 0.0001 to 0.0010, molybdenum from 0.0001 to 0.0010, nickel from 0.00005 to 0.0002, selenium from 0.010 to 0.070, tin from 0.0001 to 0.0010, vanadium from 0.00001 to 0.00007 and zinc from 0.010 to 0.070.

16. The method of enhancing the taste of a beer with a mineral additive according to claim 15 wherein a most preferred proportion of each group C element is as follows; boron is about 0.019, chromium is about 0.0001, cobalt is about 0.0001, copper is about 0.0043, iodine is about 0.0013, lithium is about 0.0004, manganese is about 0.0004, molybdenum is about 0.0005, nickel is about 0.0001, selenium is about 0.034, tin is about 0.0004, vanadium is about 0.00003 and zinc is about 0.026.

17. The method of enhancing the taste of a beer with a mineral additive according to claim 10 wherein a range of proportions of the group D element present in the mineral additive preparation is as follows: iron is from 0.002 to 0.012.

18. The method of enhancing the taste of a beer with a mineral additive according to claim 17 wherein the proportion of iron is about 0.005.

19. The method of enhancing the taste of a beer with a mineral additive according to claim 1 wherein the group A minerals are made up separately and a buffer or acid is added to the group A minerals to adjust the pH of the group A minerals.

20. The method of enhancing the taste of a beer with a mineral additive according to claim 1 wherein the pH of the finished beer is adjusted to be in the range of 3.5 through to 5.0.

21. The method of enhancing the taste of a beer with a mineral additive according to claim 20 wherein the pH of the finished beer is no higher than 4.7.

22. The method of enhancing the taste of a beer with a mineral additive according to claim 20 wherein the pH of the finished beer is in the range of about 3.8 to about 4.5.

23. The method of enhancing the taste of a beer with a mineral additive according to claim 20 wherein the pH of a preparation of either the group A minerals or the mineral additive preparation is brought below about 4.5, to bring the suspension of Ca and Mg into solution.

24. The method of enhancing the taste of a beer with a mineral additive according to claim 22 wherein the pH is adjusted by an acceptable organic or mineral acid.

25. The method of enhancing the taste of a beer with a mineral additive according to claim 24 wherein the acid is phosphoric acid.

26. The method of enhancing the taste of a beer with a mineral additive according to claim 24 wherein the pH is adjusted to about 4.0.

27. The method of enhancing the taste of a beer with a mineral additive according to claim 2 wherein the dilution is less than about 50%.

28. The method of enhancing the taste of a beer with a mineral additive according to claim 2 wherein dilution of the base beer is greater than about 20% and the mineral additive preparation is added to the base beer before gassing with carbon dioxide.

29. The method of enhancing the taste of a beer with a mineral additive according to claim 1 wherein dilution of the base beer is less than about 5% the mineral additive is added after the base beer has been diluted with water and gassed with carbon dioxide.

30. The method of enhancing the taste of a beer with a mineral additive according to claim 29 wherein one or more of the minerals is added in dry form.

31. The method of enhancing the taste of a beer with a mineral additive according to claim 1 wherein calcium is provided or partially provided in the form of calcium hydroxide Ca(OH)₂ and magnesium is provided or partially provided in the form of Mg(OH)₂ (magnesium hydroxide).

32. The method of enhancing the taste of a beer with a mineral additive according to claim 1, wherein:
phosphorous is provided or partially provided in the form of KH₂PO₄ (monobasic potassium phosphate);
potassium is provided or partially provided in the form of KH₂PO₄ (monobasic potassium phosphate) or KHCO₃ (potassium bicarbonate);
silicon is provided in the form of Na₂SiO₃.5H₂O (sodium metasilicate);
sodium is provided wholly or partially in a form selected from the group consisting of NaHCO₃ (sodium bicarbonate), Na₂B₄O₇.10H₂O (sodium tetraborate), NaCl (sodium chloride), Na₂MoO₄.2H₂O (sodium molybdate), Na₂SeO₄.10H₂O (sodium selenate), Na₂SeO₃ (sodium selenite), Na₂SiO₃.5H₂O (sodium silicate), Na₂SO₄ and Na₂SO₄.10H₂O (sodium sulphate); and
chlorine is provided wholly or partially in a form selected from the group consisting of NaCl (sodium chloride), KCl (potassium chloride), CaCl₂ (calcium chloride) and MgCl₂ (magnesium chloride).

33. The method of enhancing the taste of a beer with a mineral additive according to claim 1, wherein, if present in the manufactured mineral water,
boron is provided wholly or partially in a form selected from one of the group consisting of Na₂B₄O₇.10H₂O (sodium tetraborate) and K₂B₄O₇.5H₂O (potassium tetraborate);
chromium is provided in the form K[Cr(SO₆H₄)₂(H₂O)₂].6H₂O (chromium potassium sulphate);
cobalt is provided wholly or partially in a form selected from one or more of the group consisting of CoK₂(SO₄)₂.6H₂O (cobaltous potassium sulphate) and CoSO₄.7H₂O (cobalt sulphate);
copper is provided wholly or partially in a form selected from one or more of the group consisting of CuSO₄.5H₂O (cupric sulphate) and CuSeO₄.5H₂O (cupric selenate);
iodine is provided as (KI) potassium iodide;
lithium is provided wholly or partially in a form selected from one or more of the group consisting of Li₂SO₄.H₂O (lithium sulphate), LiCl (lithium chloride) or Li₂SeO₄.H₂O (lithium selenate);
manganese is provided wholly or partially in a form selected from one or more of the group consisting of MnSo₄.H₂O (manganous sulphate) MnCl₂.4H₂O (manganous chloride);
molybdenum is provided in the form of Na₂MoO₄.2H₂O (sodium molybdate); nickel is provided in the form of NiSO₄.6H₂O (nickel sulphate);
selenium is provided wholly or partially in a form selected from one or more of the group consisting of Na₂SeO₄.10H₂O (sodium selenate), K₂SeO₄ (potassium selenate), MgSeO₄ (magnesium selenate) and Na₂SeO₃ (sodium selenite);
tin is provided in the form of Tin SnCl₂.2H₂O (stannous chloride);
vanadium is provided in the form of NH₄VO₃ (ammonium vanadate); and
zinc is provided wholly or partially in a form selected from one or more of the group consisting of ZnSO₄.H₂O and ZnSO₄.7H₂O (zinc sulphate).

34. The method of enhancing the taste of a beer with a mineral additive according to claim 1, wherein, if present in the manufactured mineral water, iron is provided in the form of FeSO₄.7H₂O (ferrous sulphate).

35. A beer made in accordance with claim 1.
